(19) United States
(12) Patent Application Publication
(10) Pub. No.: US 2015/0337979 A1
(43) Pub. Date: Nov. 26, 2015

(54) VALVE APPARATUS HAVING A DETENT MEMBER

(71) Applicant: YTS Co., Ltd, Chiba (JP)

(72) Inventors: Minoru MURATA, Tokyo (JP); Shigeru MURATA, Chiba (JP)

(21) Appl. No.: 14/554,317

(22) Filed: Nov. 26, 2014

(30) Foreign Application Priority Data
May 23, 2014 (JP) 2014-106624

(51) Int. Cl. F16K 21/04; F16K 11/06

(52) U.S. Cl. CPC F16K 21/04; F16K 11/06

(57) ABSTRACT

A valve apparatus has a valve housing, a valve element displaceable along a rectilinear path between first and second positions within the valve housing, and a C-shaped detent member. The detent member has a central portion located intermediate between two positions in the direction of the rectilinear path that the joint between the detent member and the valve element assumes when the valve element is positioned at the first and second positions. When the valve element is moved between the first and second positions, the detent member pivots about the central portion. When the valve element is in an intermediate position between the first and second positions, the detent member is deformed to a maximum to urge the valve element to move to the first or second position. The detent member has spring portions extending from the opposite ends of the central portion. Each spring portion has at least one looped portion curved 360 degrees.

### TECHNICAL FIELD

The present invention relates to two-position valve apparatus and, more particularly, to a self-holding two-position valve apparatus having a detent device.

### BACKGROUND OF THE INVENTION

A two-position valve apparatus has a detent device to allow a valve element to be held in either of first and second positions and to prevent the valve element from remaining in an intermediate position between the first and second positions. Japanese Examined Patent Publication No. Hei 06-31650, for example, discloses a diaphragm pump having two pump chambers and using a spool valve linearly movable between first and second position for alternately supplying and discharging a drive fluid into and from two pump drive chambers. The spool valve has a detent device attached to an end thereof The detent device has a pair of detent members each formed from a linear spring material (wire) bent or curved into a C shape having a rectilinear central portion and two U-turned side portions extending from the left and right ends of the central portion. The detent members are disposed at the opposite sides of the end of the spool valve. The central portions of the detent members are pivotally attached to diametrically opposite side portions of a valve housing wall respectively, and the ends of the detent members are connected to the corresponding diametrically opposite sides of the spool valve so that the detent members are deflected at a maximum when the spool valve comes to an intermediate position of the linear movement path of the spool valve between the first position and the second position, wherein the central portions and the opposite ends of the detent members are positioned in a plane substantially perpendicular to the linear movement path of the spool valve. Accordingly, the detent members store a maximum urging force when the spool valve is moved to the intermediate position, and when the spool valve is displaced to pass the intermediate position, the detent members urge the spool valve to move to the first or second position.

Japanese Patent No. 2706688 discloses a reciprocating pump performing pumping action by reciprocating a plunger, in which a detent device similar to the above is provided in a poppet type valve apparatus for supplying and discharging a drive fluid to drive the plunger.

In the above-described valve apparatuses, the detent members are repeatedly deformed every time the valve is moved between the first and second positions. Therefore, when the detent members are deformed more than a predetermined times, the spring material constituting each detent member has a fatigue crack, and eventually, the detent member is broken.

### SUMMARY OF THE INVENTION

Accordingly, it is desirable to enable the detent members of such a detent device to be used for as long a period of time as possible.

The present invention has been made in view of the above-described circumstances, and an object of the present invention is to provide a two-position valve apparatuses such as disclosed in the above-described Japanese Patent Documents wherein the durability of a detent member(s) used therein is improved.

Another object of the present invention is to provide a detent member for use in the valve apparatus of the present invention.

The present invention provides a valve apparatus including a valve housing, a valve element displaceable along a rectilinear path between first and second positions in the valve housing, and a detent member formed from a linear spring material into a C shape as a whole. The detent member has a central portion installed in a stationary position relative to the valve housing. The stationary position is spaced from the rectilinear path in a direction traversing the rectilinear path. The detent member further has first and second spring portions extending leftward and rightward from left and right ends, respectively, of the central portion in a lateral direction with respect to the rectilinear path and being curved to reach the valve element and connected to the valve element. The stationary position in which the central portion is installed is located intermediate between two positions in the direction of the rectilinear path that the joint between the detent member and the valve element assumes when the valve element is positioned at the first and second positions. The central portion of the detent member is pivotable in the stationary position, so that the detent member pivots about the central portion when the valve element is displaced between the first and second positions. The first and second spring portions each have at least one looped portion curving 360 degrees.

In the valve apparatus according to the present invention, when the valve element is in the first position and in the second position, the detent member holds the valve element in the first position and in the second position with relatively low spring forces, respectively. When the valve element moves between the first and second positions, the deformation of the detent member gradually increases as the valve element approaches an intermediate position between the first and second positions (specifically, a third position where the joints between the first and second spring portions of the detent member and the valve element are positioned in a plane perpendicular to the rectilinear movement path of the valve element containing the central portion of the detent member therein). The detent member is deformed to a maximum at the intermediate position to store a maximum spring force. Consequently, once the valve element passes the third position when being moved from the first position toward the second position, the detent member urges the valve element to move to the second position with the stored urging force (stored spring force). When the valve element is moved reversely, the detent member urges the valve element to move to the first position with the stored urging force once the valve element passes the third position. The deformation of the detent member is borne mainly by the first and second spring portions. In the valve apparatus according to the present invention, each spring portion has the above-described looped portion; therefore, the deformation of the detent member is also borne by the looped portion. That is, each spring portion is longer in length and hence smaller in spring constant than a spring portion formed by using a linear spring material of the same diameter with no looped portion.

The above-described characteristics of the detent member of the valve apparatus according to the present invention make it possible to offer the following technical advantages:

Let us compare the detent member having the looped portion according to the present invention with a detent member having no looped portion on the assumption that the positional relation between the installation position of the central portion of the detent member and the joint positions of the detent member to the valve element is the same for the two detent members. In order for the detent member having the looped portion to have the same spring constant as that of the detent member having no looped portion, the spring material constituting the detent member with the looped portion should be increased in diameter. In this case, the maximum stress produced on the cross-section of the spring material of the detent member with the looped portion is reduced because the spring material thereof has the increased diameter. Accordingly, it becomes unlikely that the detent member with the looped portion will have a fatigue crack even when the valve element is repeatedly displaced between the first and second positions a predetermined times whereas the detent member with not looped portion will have a fatigue crack with the repetition of the displacement of the valve element of the predetermined times.

To obtain the same holding force at the first and second positions as that of the detent member having no looped portion by using the detent member whose spring constant has been reduced by providing the looped portion as stated above, the arrangement should be configured to increase the amount of deformation of the spring portions of the detent member when the valve element is in the first and second positions. Specifically, it is conceivable that the first and second positions may be set closer to the above-described intermediate position in the direction of the rectilinear path of the valve element. In this case, the amount of deformation of the detent member when the valve element reaches the intermediate position from either of the first and second positions is reduced; therefore, it is possible to reduce force necessary for the valve element to pass the intermediate position. In short, it is possible to reduce force for moving the valve element from either of the first and second positions toward the intermediate position.

The first and second spring portions may have the looped portions inside respective curves thereof.

The looped portions may be provided outside curves thereof However, providing the looped portions inside enables the length of the spring portions to be extended efficiently within the installation space of the detent member in the valve housing.

There may be provided a plurality of the looped portions of the same diameter and extending spirally.

With the above-described configuration, the foregoing technical advantages can be obtained even more efficiently.

As another embodiment of the present invention, the first and second spring portions may each comprise a plurality of spring portions provided therealong.

In addition, the present invention provides the above-described detent member used in the foregoing valve apparatus.

Embodiments of a valve apparatus according to the present invention will be explained below with reference to the accompanying drawings.

### BRIEF DESCRIPTION OF THE DRAWINGS

FIG. 1 is a sectional view outlining an example in which a valve apparatus having a detent device according to the present invention is combined with a diaphragm pump.

FIG. 2 is a sectional view taken along the line II-II in FIG. 1.

FIG. 3 is an illustration showing another embodiment of a detent member according to the present invention.

### DETAILED DESCRIPTION OF THE INVENTION

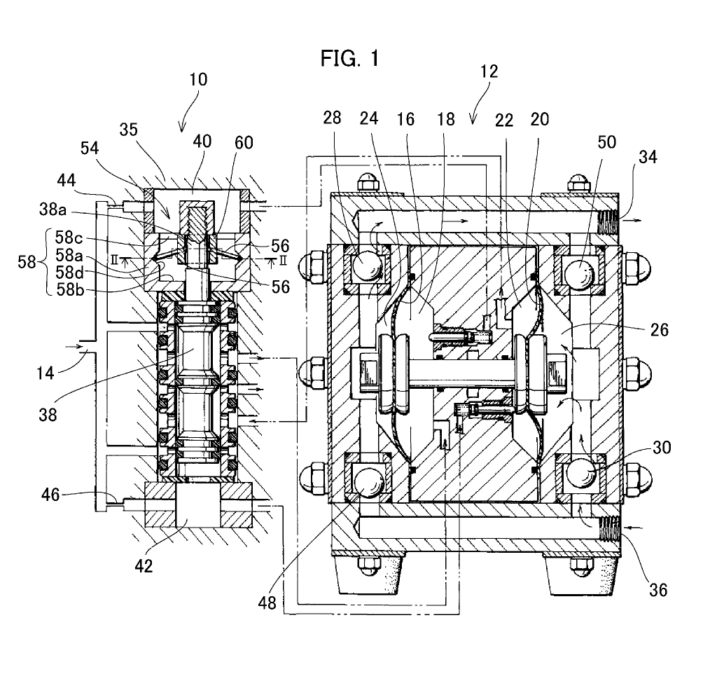

FIG. 1 shows an embodiment in which a five-port two-position spool valve apparatus 10 according to the present invention is used to control a diaphragm pump 12 in the same way as disclosed in the above-described Japanese Examined Patent Publication No. Hei 06-31650. The following is a brief explanation of the relationship between the spool valve apparatus 10 and the diaphragm pump 12. In the illustrated state, a drive fluid introduced from a drive fluid (compressed air) inlet 14 passes through a path shown by the arrows and is supplied into a drive chamber 18 located at the right side of a left diaphragm 16 (as seen in the figure), and the drive fluid in a drive chamber 22 at the left side of a right diaphragm 20 passes through an arrowed path extending through the valve apparatus 10 and is discharged into the atmosphere. A pump chamber 24 located at the left side of the left diaphragm 16 and a pump chamber 26 at the right side of the right diaphragm 20 are communicated with a pump discharge opening 34 and a pump suction opening 36 through check valves 28 and 30, respectively. Accordingly, the diaphragms 16 and 20 are bent leftward as shown in the figure to perform pumping operation through the pump suction opening 36 and the pump discharge opening 34.

The spool valve apparatus 10 has a valve housing 35 slidably accommodating a spool valve element 38. The valve housing 35 has switching pressure chambers 40 and 42 into which the opposite ends of the spool valve element 38 face, respectively. The switching pressure chambers 40 and 42 are communicated with the drive fluid inlet 14 through respective restrictors 44 and 46. Thus, the fluid pressure at the drive fluid inlet 14 is equally transmitted to the switching pressure chambers 40 and 42. The switching pressure chambers 40 and 42 are also communicated with the drive chambers 18 and 22, respectively. Accordingly, in the illustrated state, the pressure in the switching pressure chamber 40 is higher than the pressure in the switching pressure chamber 42, thus causing the spool valve element 38 to be driven downward from the position shown in the figure. When the spool valve element 38 is driven downward from the illustrated position, the fluid connection between the ports of the spool valve apparatus 10 and the drive chambers 18 and 22 of the diaphragm pump 12 is switched over to supply the drive fluid from the drive fluid inlet 14 into the right drive chamber 22 and to discharge the drive fluid from the left drive chamber 18 into the atmosphere through the valve apparatus 10. Consequently, the left and right diaphragms 16 and 20 are deflected rightward to perform a pump suction operation through the pump suction opening 36 communicated with the pump chamber 24 through a check valve 48 and a pump discharge operation through the pump discharge opening 34 communicated with the pump chamber 26 through a check valve 50.

The spool valve apparatus 10 has, as has been stated above, the valve housing 35 slidably accommodating the spool valve element 38, and the valve housing 35 is provided therein with the switching pressure chambers 40 and 42 into which the opposite ends of the spool valve element 38 face, respectively. Thus, the spool valve element 38 is brought into either a first position shown in FIG. 1 or a second position axially below the first position as seen in Fig. according to the difference between the pressures in the switching pressure chambers 40 and 42.

It is necessary, in order to allow the diaphragm pump 12 to operate properly, to prevent the spool valve element 38 from remaining in an intermediate position between the above-described first and second positions. For this purpose, in the illustrated example, a detent device 54 is provided in the switching pressure chamber 40. The detent device 54 is basically the same in structure as that disclosed in the above-described Japanese Examined Patent Publication No. Hei 06-31650. That is, the detent device 54 has a pair of detent members 56 each formed from a linear spring material (wire) bent or curved into a C shape. The detent members 56 are installed between an outer tubular support 58 fitted in the switching pressure chamber 40 and an inner tubular support 60 attached around an extension end portion 38a of the spool valve element 38.

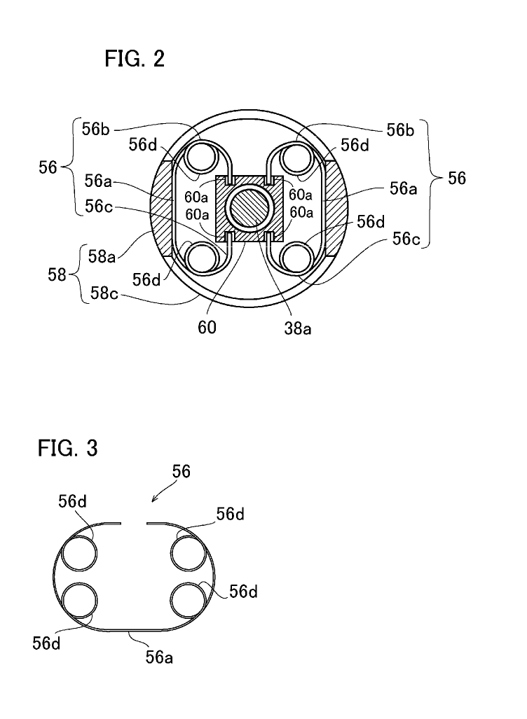

The outer tubular support 58 has a pair of support portions 58a at diametrically opposite positions (see FIGS. 1 and 2). The outer tubular support 58 further has a disk portion 58b connected to the lower ends of the support portions 58a, and a ring portion 58c connected to the upper ends of the support portions 58a. The support portions 58a are provided with respective rectilinear support grooves 58d of V-shaped cross-section as seen in FIG. 1 which extend parallel to each other in a plane perpendicular to the axis of the spool valve element 38.

Each detent member 56 has, as shown in FIG. 2, a rectilinear central portion 56a installed in the associated support groove 58d of the outer tubular support 58, and first and second spring portions 56b and 56c extending respectively from the opposite ends of the central portion 56a and being curved in a U-shape to reach the inner tubular support 60. The distal ends of the first and second spring portions 56b and 56c are inserted into connection holes 60a, respectively, formed in the inner tubular support 60 and thus connected to the inner tubular support 60. When the spool valve element 38 moves between the above-described first and second positions, the detent members 56 pivot about the respective central portions 56a. Specifically, the central portion 56a of each detent member 56 is located intermediate between two positions in the direction of the rectilinear path of the spool valve element 38 that the joint between the detent member 56 and the spool valve element 38 at the connection holes 60a assumes when the spool valve element 38 is positioned at the first and second positions.

As shown in FIG. 2, the first and second spring portions 56b and 56c each have a looped portion 56d inside the U-shaped curve thereof. The looped portion 56d is curved 360 degrees. The looped portions 56d allow the length of the material (wire) of the first and second spring portions 56b and 56c to be longer than when there are no looped portions 56d, thereby reducing the spring constant of the first and second spring portions 56b and 56c, and thus making it possible to offer the technical advantages described in the summary of the invention. Such a looped portion may be provided outside the U-shaped curve of each spring portion. In such a case, however, the extent to which the length of the material (wire) of the spring portion may be extended is smaller for the same installation space in the valve housing than when the looped portion is provided inside the U-shaped curve. Each looped portion 56d may comprise a plurality of looped portions of the same diameter coaxially formed in series like a coil spring. As shown in FIG. 3, each detent member 56 may have a plurality of looped portions 56d formed along the length of the associated spring portion.

The spool valve apparatus 10 performs the above-described pumping operation using a drive fluid introduced thereinto from the drive fluid inlet 14. When the pumping operation is performed with the spool valve element 38 placed in the position shown in FIG. 1, for example, the pressure in the switching pressure chamber 40 is greater than the pressure in the switching pressure chamber 42, thus causing the spool valve element 38 to be moved toward the second position below the first position as seen in the figure. At this time, each detent member 56 pivots about the central portion 56a. The spring portions 56b and 56c of the detent member 56 are gradually deformed as the spool valve element 38 approaches the third position (intermediate position) where the joints between the detent members 56 and the inner tubular support 60, i.e. the distal ends of the spring portions 56b and 56c, are positioned in a plane substantially perpendicular to the rectilinear path of the valve element 38. The spring portions 56b and 56c are deformed to a maximum at the third position to store a maximum spring force. Therefore, once the spool valve element 38 passes the third position when being moved from the first position toward the second position, the detent member 56 urges the spool valve element 38 to move to the second position with the stored urging force (stored spring force). When the spool valve element 38 is moved reversely, the detent member 56 urges the spool valve element 38 to move to the first position with the stored urging force when the spool valve element 38 passes the third position. Thus, it is possible to prevent the spool valve element 38 from remaining in an intermediate position between the first and second positions.

Although some embodiments of the valve apparatus according to the present invention have been described above, the present invention is not limited to the described embodiments. For example, in the foregoing embodiments, the valve apparatus according to the present invention has been explained in relation to a diaphragm pump. However, the valve apparatus of the present invention may also be used to control a reciprocating pump of piston-cylinder type such as that disclosed in the above-described Japanese Patent No. 2706688. Although in the foregoing embodiments the present invention is applied to a spool valve apparatus, the present invention is also applicable to a poppet type valve apparatus such as that disclosed in the above-described Japanese Patent No. 2706688.

1. A valve apparatus comprising:
a valve housing;
a valve element displaceable along a rectilinear path between first and second positions in the valve housing; and
a detent member formed from a linear spring material into a C shape as a whole, the detent member having a central portion installed in a stationary position relative to the valve housing, the stationary position being spaced from the rectilinear path in a direction traversing the rectilinear path, the detent member further having first and second spring portions extending leftward and rightward from left and right ends, respectively, of the central portion in a lateral direction with respect to the rectilinear path and being curved to reach the valve element and connected to the valve element;
wherein the stationary position in which the central portion is installed is located intermediate between two positions in a direction of the rectilinear path that a joint between the detent member and the valve element assumes when the valve element is positioned at the first and second positions;
the central portion being pivotable in the stationary position, so that the detent member pivots about the central portion when the valve element is displaced between the first and second positions;
the first and second spring portions each having at least one looped portion that curves 360 degrees.

2. The valve apparatus of claim 1, wherein the first and second spring portions have the loops inside respective curves thereof.

3. The valve apparatus of claim 1, wherein the first and second spring portions each comprise a plurality of the loops provided therealong.

4. The detent member used in the valve apparatus of claim 1.

5. The detent member of claim 4, wherein the central portion is rectilinear, and the loops are provided inside respective curves of the first and second spring portions.
